(19) United States
(12) Patent Application Publication
(10) Pub. No.: US 2012/0150577 A1
(43) Pub. Date: Jun. 14, 2012

(54) MEETING LIFECYCLE MANAGEMENT

(75) Inventors: Jeffrey S. Berg, Seattle, WA (US); Nathan James Fish, Seattle, WA (US); Joo Young Lee, Redmond, WA (US); Kuldeep Karnawat, Seattle, WA (US); Derek Matthias Hans, Seattle, WA (US); David B. Lee, Sammamish, WA (US); Xiping Zuo, Kirkland, WA (US); Nicole Danielle Steinbok, Redmond, WA (US); Nina F. Shih, Redmond, WA (US); Peter B. Rodes, Seattle, WA (US); Leslie Rae Ferguson, Seattle, WA (US); Joseph F. Friend, Bothell, WA (US)

(73) Assignee: MICROSOFT CORPORATION, Redmond, WA (US)

(21) Appl. No.: 12/967,497

(22) Filed: Dec. 14, 2010

(51) Int. Cl. G06Q 10/00; G06Q 90/00

(52) U.S. Cl. 705/7.12; 705/1.1; 705/342; 705/500

(57) ABSTRACT

A meeting lifecycle management service manages various aspects of a meeting lifecycle. An indication of a newly scheduled meeting is received at the meeting lifecycle management service, and information related to the meeting is managed, via the meeting lifecycle management service, prior to the meeting, during the meeting, and after the meeting.

### BACKGROUND

Many people, particularly in business environments, oftentimes plan and participate in meetings. Various programs are available that can be used to facilitate planning or participating in meetings, such as calendaring or scheduling programs that allow a user of the program to set a time and location for the meeting as well as send out invitations to other meeting participants. While using such programs can be helpful, they are typically limited in their functionality (e.g., being limited to this scheduling functionality).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, an indication of a newly scheduled meeting is received at a centralized meeting lifecycle management service. Information related to the meeting is managed, via the centralized meeting lifecycle management service, prior to the meeting, during the meeting, and after the meeting ends.

In accordance with one or more aspects, a meeting lifecycle management service identifies a request for a meeting submitted by a user. The meeting lifecycle management service collects one or more documents for the meeting prior to the meeting, and makes the one or more documents available to users before, during, and after the meeting. The one or more documents can also be tailored, for each of multiple users, to a type of computing device being used by that user.

### BRIEF DESCRIPTION OF THE DRAWINGS

The same numbers are used throughout the drawings to reference like features.

FIG. 1 illustrates an example system implementing the meeting lifecycle management in accordance with one or more embodiments.

FIG. 2 illustrates another example system implementing the meeting lifecycle management in accordance with one or more embodiments.

FIG. 3 illustrates an example meeting lifecycle management service in accordance with one or more embodiments.

FIG. 4 is a flowchart illustrating an example process for meeting lifecycle management in accordance with one or more embodiments.

FIG. 5 is a flowchart illustrating another example process for meeting lifecycle management in accordance with one or more embodiments.

FIG. 6 illustrates an example computing device that can be configured to implement at least parts of the meeting lifecycle management in accordance with one or more embodiments.

### DETAILED DESCRIPTION

Meeting lifecycle management is discussed herein. A meeting lifecycle management service provides management and coordination of various aspects of a meeting lifecycle. The meeting lifecycle includes the time during the meeting, as well as the time prior to the meeting and the time after the meeting. The meeting lifecycle management service manages information related to the meeting, such as invitees to the meeting, attendees of the meeting, documents planned to be presented at the meeting, documents presented at the meeting, and so forth. The meeting lifecycle management service operates as a source of this information related to a meeting or meetings before, during, and after the meeting or meetings.

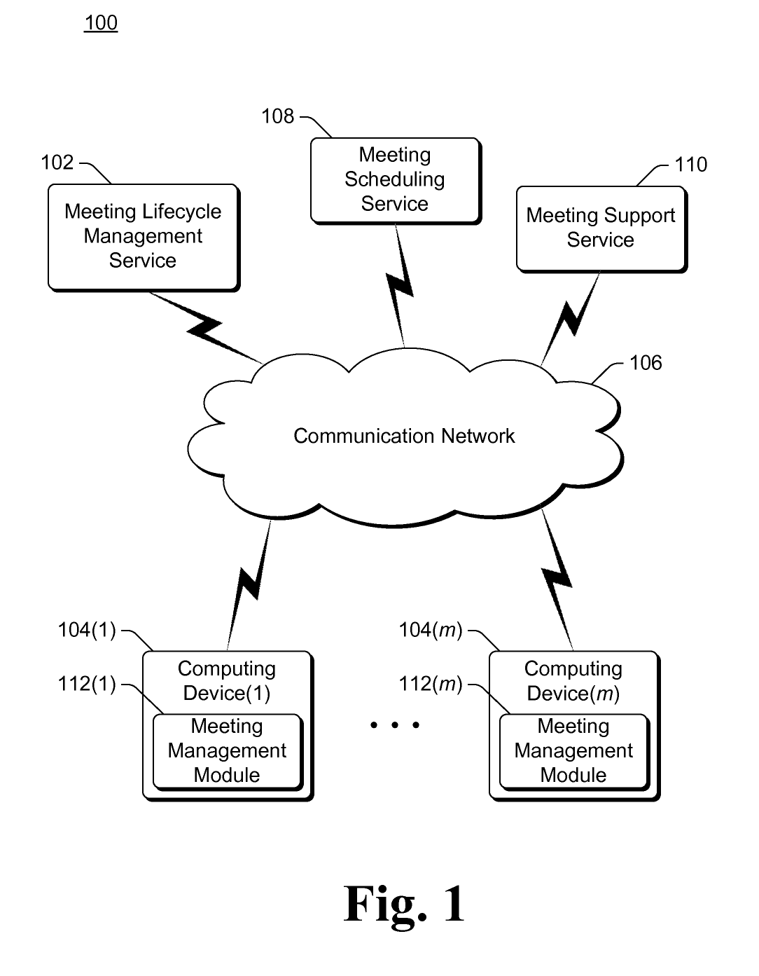

FIG. 1 illustrates an example system 100 implementing the meeting lifecycle management in accordance with one or more embodiments. System 100 includes a meeting lifecycle management service 102 that can communicate with one or more (m) computing devices 104 via a network 106. Network 106 can be a variety of different types of networks, including the Internet, a local area network (LAN), a public telephone network, an intranet, other public and/or proprietary networks, combinations thereof, and so forth.

Each computing device 104 can be a variety of different types of devices. For example, computing device 104 can be a desktop computer, a laptop or netbook computer, a mobile station, an entertainment appliance, a set-top box communicatively coupled to a display device, a television or other display device, a cellular or other wireless phone, a game console, an automotive computer, and so forth. Different computing devices 104 can be the same types of devices or different types of devices.

Meeting lifecycle management service 102 manages information related to a meeting during the meeting lifecycle. The meeting lifecycle begins when the meeting is requested or scheduled, and can end at various times. For example, the meeting lifecycle can end when a user of meeting lifecycle management service 102 (e.g., a user that schedules a meeting) desires the meeting lifecycle to end (e.g., when the user deletes the information related to the meeting lifecycle from the meeting lifecycle management service). By way of another example, a developer or administrator of meeting lifecycle management service 102 can configure the meeting lifecycle to end at particular times and/or in response to different events. Thus, the meeting lifecycle includes the time during the meeting, as well as an amount of time prior to the meeting and an amount of time after the meeting. A meeting refers to any gathering of two or more people, and can include people gathering face-to-face (e.g., in the same room or at the same location), people communicating via an audio and/or video conference, combinations thereof, and so forth.

Meeting lifecycle management service 102 manages a variety of information related to the meeting. This information related to the meeting can include information regarding the people involved in the meeting, such as invitees to the meeting, attendees of the meeting, duration of attendance for attendees of the meeting, times when attendees joined and/or left the meeting, the user that scheduled the meeting, and so forth. This information related to the meeting can also include information regarding the location and/or access to the meeting, such as the meeting time, the building and/or room for the meeting, the address of the building for the meeting, one or more telephone numbers to call to join the meeting, which users joined the meeting in what manners (e.g., in-person, calling a telephone number, etc.), and so forth. This information related to the meeting can also include information regarding content associated with the meeting. Such content, also referred to as meeting content, includes various documents, files, recordings, portions thereof, and so forth. For example, such content can include documents (or portions thereof) planned to be presented at the meeting, documents (or portions thereof) presented at the meeting, audio and/or video recordings of the meeting, an agenda for the meeting, notes taken during the meeting, communications (e.g., instant messages, text message, etc.) made during the meeting, and so forth.

Meeting lifecycle management service 102 optionally works in conjunction with meeting scheduling service 108 and meeting support service 110. Meeting scheduling service 108 provides meeting scheduling functionality to computing devices 104, and users of computing devices 104 can interact with meeting scheduling service 108 to schedule meetings. This scheduling can include selecting the meeting location, selecting the meeting time, selecting meeting invitees, sending a meeting request, and so forth. Meeting scheduling service 108 can also work in conjunction with a scheduling module on computing devices 104. In one or more embodiments, meeting scheduling service 108 implements the Microsoft Exchange Server program to provide the meeting scheduling functionality, and one or more of computing devices 104 can optionally implement the Microsoft Outlook® email and calendar program to facilitate scheduling meetings. Alternatively, rather than being a separate service, meeting scheduling service 108 can be implemented as part of meeting lifecycle management service 102. Additionally, although a single meeting scheduling service 108 is illustrated in system 100, alternatively system 100 can include multiple meeting scheduling services 108.

Meeting support service 110 provides various functionality to support meeting lifecycle management service 102 and/or meetings managed by meeting lifecycle management service 102. A variety of different functionality can be provided by meeting support service 110, such as storage of meeting content, video conferencing services, audio conferencing services, and so forth. Alternatively, rather than being a separate service, meeting support service 110 can be implemented as part of meeting lifecycle management service 102. Additionally, although a single meeting support service 110 is illustrated in system 100, alternatively system 100 can include multiple meeting support services 110.

Each computing device 104 includes a meeting management module 112. Meeting management module 112 communicates with meeting lifecycle management service 102, receiving data or information from meeting lifecycle management service 102 and providing data or information to meeting lifecycle management service 102. Meeting management module 112 displays or otherwise presents a user interface to users of computing device 104, allowing users to view information related to a meeting, add information to a meeting, and so forth. Meeting management module 112 can be a standalone module or alternatively incorporated into one or more other modules or programs. For example, meeting management module 112 can be included as part of a local email and calendar program on computing device 102.

Meeting management module 112 receives user inputs from a user of computing device 104. User inputs can be provided in a variety of different manners, such as by pressing one or more keys of a keypad or keyboard of device 104, pressing one or more keys of a controller (e.g., remote control device, mouse, trackpad, etc.) of device 104, pressing a particular portion of a touchpad or touchscreen of device 104, making a particular gesture on a touchpad or touchscreen of device 104, and/or making a particular gesture on a controller (e.g., remote control device, mouse, trackpad, etc.) of device 104. User inputs can also be provided via other physical feedback input to device 104, such as tapping any portion of device 104, an action that can be recognized by a motion detection component of device 104 (such as shaking device 104, rotating device 104, etc.), and so forth. User inputs can also be provided in other manners, such as via audible inputs to a microphone, via motions of hands or other body parts observed by an image capture device, and so forth.

These user inputs allow a user to interact with computing device 104. For example, a user can input particular characters or symbols. By way of another example, a user can input a request such as selecting a particular button or icon, selecting a menu option, dragging and dropping various descriptions or images, and so forth. These user inputs also allow single-touch actions for making a request, such as a single click (e.g., of a key of a controller), a single touch (e.g., of a touchpad or touchscreen), a single swipe or other gesture (e.g., on a touchpad or touchscreen), and so forth. These user inputs also allow for multi-touch actions for making a request, such as multiple clicks (e.g., of one or more keys of a controller), multiple touches (e.g., of a touchpad or touchscreen), multiple swipes or other gestures (e.g., on a touchpad or touchscreen), combinations of one or more clicks, touches, swipes and/or gestures, and so forth.

Meeting management module 112 can also provide additional data or information to meeting lifecycle management service 102. In one or more embodiments, meeting management module 112 provides to meeting lifecycle management service 102 an indication of a type or class of device implementing module 112. This allows meeting lifecycle management service 102 to tailor meeting content to that particular type or class of device, as discussed in more detail below. Additionally, in one or more embodiments meeting lifecycle management service 102 provides to meeting lifecycle management service 102 an indication of a current user of computing device 104. This current user can be, for example, a current user logged into computing device 104, a current user logged into meeting scheduling service 108, a current user logged into a meeting support service 110, and so forth. The indication provided to meeting lifecycle management service 102 can be a user identifier of the current user of computing device 104 (e.g., the user identifier provided by the user in logging into computing device 104, contact information (e.g., email address or telephone number) of the user, etc.). Meeting lifecycle management service 102 maintains a record of which user is logged into which computing device 104 at a particular time, allowing meeting lifecycle management service 102 to know which computing devices 104 are being used by which meeting invitees at any particular time.

In one or more embodiments, meeting lifecycle management service 102 is a centralized service that manages various information related to the meeting. In such embodiments, meeting lifecycle management service 102 receives various data and information from meeting management modules 112 and optionally meeting scheduling service 108 and/or meeting support service 110. Meeting lifecycle management service 102 maintains (e.g., stores) this received data and information and also provides various data and information to meeting management modules 112 and optionally meeting scheduling service 108 and/or meeting support service 110, allowing various information related to the meeting to be presented to users of computing devices 104. Alternatively, various functionality of meeting lifecycle management service 102 can be distributed to and provided by other modules or services, such as meeting support service 110, meeting scheduling service 108, and/or meeting management module 112, combinations thereof, and so forth.

Each of meeting lifecycle management service 102, meeting scheduling service 108, and meeting service 110 is typically implemented on one or more server computers. Alternatively, each of meeting lifecycle management service 102, meeting scheduling service 108, and meeting service 110 can be implemented on one or more of a variety of different types of computing devices (e.g., a desktop computer, a laptop or netbook computer, a mobile station, an entertainment appliance, a set-top box communicatively coupled to a display device, a television or other display device, a cellular or other wireless phone, a game console, an automotive computer, and so forth). Furthermore, the functionality discussed herein with reference to each of meeting support service 110 and meeting scheduling service 108 can be distributed to and provided by other modules or services, such as meeting lifecycle management service 102, meeting management module 112, combinations thereof, and so forth.

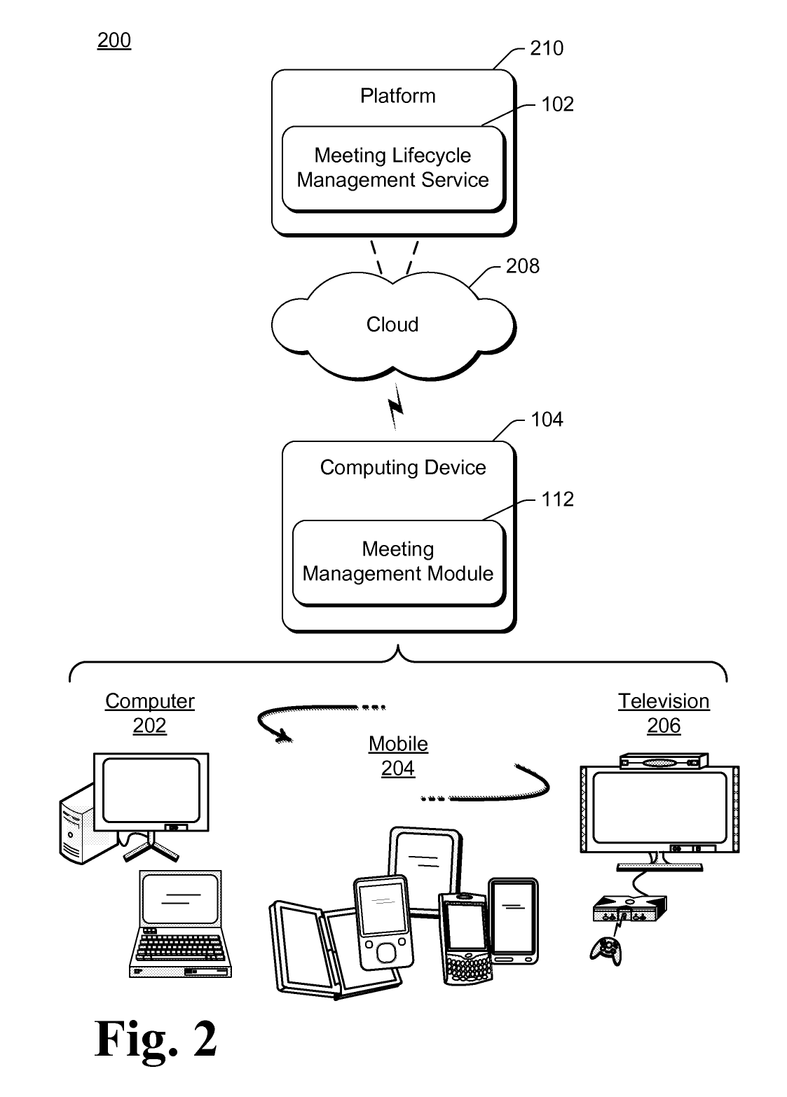

FIG. 2 illustrates another example system 200 implementing the meeting lifecycle management in accordance with one or more embodiments. The example system 200 enables ubiquitous environments for a seamless user experience when running applications on any type of computer, television, and/or mobile device. Services and applications run substantially similar in all environments for a common user experience when transitioning from one device to the next while utilizing an application, playing a video game, watching a video, viewing a document, and so on.

In the example system 200, multiple devices can be interconnected through a central computing device, which may be local to the multiple devices or may be located remotely from the multiple devices. In one or more embodiments, the central computing device may be a cloud of one or more server computers that are connected to the multiple devices through a network, the Internet, or other data communication link. In one or more embodiments, this interconnection architecture enables functionality across multiple devices to provide a common and seamless experience to a user of the multiple devices. Each of the devices may have different physical requirements and capabilities, and the central computing device uses a platform to enable delivery of an experience that is both tailored to a particular device and yet common to all of the devices. In one or more embodiments, a class of target devices is created and user experiences are tailored to the generic class of devices. A class of devices may be defined by physical features, types of usage, or other common characteristics of the devices.

In various implementations, the computing device 104 may be implemented in a variety of different configurations, such as for computer 202, mobile 204, and television 206 uses. Each of these configurations includes devices that may have generally different constructs and capabilities, and the computing device may be configured according to one or more of the different device classes. For example, the computing device 104 may be implemented as any type of a personal computer, desktop computer, a multi-screen computer, laptop computer, tablet, netbook, and so on.

The computing device 104 may also be implemented as any type of mobile device, such as a mobile phone, portable music player, portable gaming device, a tablet computer, a multi-screen computer, and so on. The computing device 104 may also be implemented as any type of television device having or connected to generally larger screens in casual viewing environments. These devices include televisions, set-top boxes, gaming consoles, and so on. The techniques described herein may be supported by these various configurations of the computing device and are not limited to the specific examples of a meeting lifecycle management service described herein.

The cloud 208 includes and/or is representative of a platform 210 for meeting lifecycle management service 102. The platform abstracts underlying functionality of hardware, such as server devices, and/or software resources of the cloud. The meeting lifecycle management service may include applications and/or data that can be utilized while computer processing is executed on servers that are remote from the computing device 104. The meeting lifecycle management service 102 can be provided as a service over the Internet and/or through a subscriber network, such as a cellular or WiFi network.

The platform 210 may abstract resources and functions to connect the computing device 104 with other computing devices. The platform may also serve to abstract scaling of resources to provide a corresponding level of scale to encountered demand for the services that are implemented via the platform. Accordingly, in an interconnected device embodiment, implementation of functionality of the meeting management module 112 may be distributed throughout the system 200. For example, the meeting management module 112 may be implemented in part on the computing device as well as via the platform that abstracts the functionality of the cloud.

Returning to FIG. 1, when a user of a computing device 104 schedules a new meeting using meeting scheduling service 108, meeting lifecycle management service 102 receives an indication of the newly scheduled meeting. This indication can be received in different manners, such as from meeting scheduling service 108 or from a module of the computing device 104. Meeting lifecycle management service 102, or alternatively another service or module, can monitor meeting scheduling service 108 for newly scheduled meetings, or alternatively meeting scheduling service 108 can notify meeting lifecycle management service 102 of newly scheduled meetings.

In one or more embodiments, when a new meeting is scheduled using meeting scheduling service 108, a meeting identifier (ID) is associated with the meeting. This meeting ID can be added by, for example, meeting scheduling service 108 or a module of the computing device 104 via which the user scheduled the meeting. Meeting lifecycle management service 102 maintains a record of this meeting ID, as well as various information related to new meeting. This information can include all of the information provided by the user in scheduling the meeting, such as invitees, meeting time, meeting location, telephone numbers for conference calls, and so forth. Invitees or meeting invitees refer to users that are invited to the meeting, which optionally includes the user scheduling the meeting. Attendees or meeting attendees refer to users that actually attended (or are attending) the meeting. This information related to the new meeting can also include information regarding other users related to meeting invitees, such as the supervisor of an invitee, a manager of a project or team that the meeting invitee is part of, and so forth). Meeting lifecycle management service 102, as well as meeting management modules 112, can also use the meeting ID to associate other meeting content (such as subsequently provided documents) with the meeting as discussed in more detail below.

Meeting lifecycle management service 102 also maintains contact information for the meeting invitees. This contact information can be, for example, email addresses, telephone numbers, other account identifiers, and so forth. This contact information can be received from meeting scheduling service 108 or alternatively a module of the computing device via which the user scheduled the meeting. Alternatively, this contact information can be received from other sources, such as another service or module of system 100. In one or more embodiments, this contact information for the meeting invitees is the contact information provided by the user in scheduling the meeting (e.g., an email address) and sending out a meeting request to the meeting invitees. Similarly, information regarding other users related to a meeting invitee can be received from various sources (e.g., meeting scheduling service 108 or another service or module). In one or more embodiments, this information is provided by another service or module that maintains a record of relationships involving meeting invitees (e.g., an employee organizational chart or record for a company or business unit, a record of which users are participating in or are members of which projects, and so forth).

In situations in which the user identifier of a meeting invitee is not the contact information for the meeting invitee, meeting lifecycle management service 102 can also maintain a record of the user identifier of each meeting invitee. The user identifier of a meeting invitee can be received in various manners, such as being included in the indication of the newly scheduled meeting, being obtained from a meeting management module 112 of a computing device, being received from another module or service, and so forth.

Meeting management module 112 allows a user to access information related to the meeting, add documents or other content to the meeting, and so forth. A user of computing device 104 identifies himself or herself to meeting management module 112, such as by logging into computing device 104 with a user identifier, logging into meeting scheduling service 108 with a user identifier, and so forth. Meeting management module 112 can provide this user identifier to meeting lifecycle management service 102, which in turn can return to meeting management module 112 indications (including meeting IDs) of all meetings with a meeting invitee having that user identifier. These returned meetings can be meetings that the user scheduled, or that were scheduled by other users and for which the user is an invitee (or attendee) of the meeting. Meeting management module 112 can thus display or otherwise present to the user of computing device 104 an indication of all meetings that include that user. These displayed indications can be meeting subjects, meeting dates and/or times, identifiers of meeting schedulers, combinations thereof, and so forth.

The user can select a meeting and receive additional information related to the meeting (before, during, and/or after the meeting), or request that new meeting content or other data be added to the meeting. The user can select a meeting in a variety of different manners, including single-touch actions (e.g., a single click, a single touch, a single swipe or other gesture), such as by selecting an identifier of the meeting, inputting a particular gesture on a touchpad or touchscreen, and so forth. In response to user selection of the meeting, meeting management module 112 obtains the information related to the meeting (if not previously obtained by meeting management module 112) and displays the information related to the meeting for the user. For example, a user can select a meeting and be presented with the date and time of the meeting, the meeting invitees, and a list of documents that have been added to the meeting.

In situations in which a user desires to add meeting content or other data to a meeting, the user can select the indication of the meeting and identify the meeting content or other data he or she desires to have added to the meeting and shared with the meeting invitees. This can be user selection of a particular one or more files, user selection of a reference to (e.g., link or pointer to) one or more files, user selection of a portion of a file, data typed in or otherwise input by the user, and so forth. Meeting management module 112 provides the meeting content or other data to be added to the meeting to meeting lifecycle management service 102, and also identifies the meeting ID for that meeting to meeting lifecycle management service 102. Meeting lifecycle management service 102 can thus store the meeting content or other data that the user adds to the meeting as being associated with the meeting.

Meeting lifecycle management service 102 also supports various functionality during a meeting. Meeting lifecycle management service 102 can receive an indication that a meeting has begun from a meeting management module 112. A user input can be used to indicate that the meeting has begun (e.g., a user selecting a “start meeting” button or icon, or selecting a link or other reference to a phone number or other identifier of a conference call, etc.). Alternatively, meeting lifecycle management service 102 can automatically determine when the meeting starts (e.g., in response to it being the time for which the meeting is scheduled to begin, in response to an indication from meeting support service 110 that a conference call for the meeting has begun, etc.).

A user can also add meeting content or other data to a meeting during the meeting, analogous to adding meeting content or other data to the meeting before the meeting. This content to be shared can be a particular document, portions of a document, and so forth. The user can select content to be shared in different manners, including single-touch actions (e.g., a single click, a single touch, a single swipe or other gesture), such as by dragging and dropping the document to a particular icon or window, selecting a particular menu option, entering a particular gesture on a touchpad or touchscreen, and so forth.

Meeting lifecycle management service 102 also maintains a record of particular content that is being presented during the meeting. Meeting lifecycle management service 102 is informed of which content is being presented by the module or service presenting that content. For example, meeting management module 112 can notify meeting lifecycle management service 102 each time a user of computing device 104 changes a page or slide in a document that the user has selected to share during the meeting. By way of another example, a meeting support service 110 providing audio and/or video conferencing services can record the audio and/or video of the meeting and provide the recording to meeting lifecycle management service 102.

Meeting lifecycle management service 102 also supports various functionality after a meeting. Meeting lifecycle management service 102 can receive an indication that a meeting has ended from a meeting management module 112. A user input can be used to indicate that the meeting has ended (e.g., a user selecting an “end meeting” button or icon). Alternatively, meeting lifecycle management service 102 can automatically determine when the meeting ends (e.g., in response to it being the time for which the meeting is scheduled to end, in response to an indication from meeting support service 110 that a conference call for the meeting has ended, etc.).

Meeting lifecycle management service 102 makes the various meeting content, including content that was added or presented during the meeting, available to meeting invitees after the meeting. After the meeting, meeting lifecycle management service 102 can optionally restrict access to particular meeting invitees (e.g., only those invitees that attended the meeting), or extend access to other users (e.g., one or more other users identified by the user that scheduled the meeting).

It should be noted that the beginning and ending of the meeting refers to the duration of the actual meeting itself, which can be identified in different manners. For example, this duration can be the time that begins when the meeting is scheduled to begin and ends when the meeting is scheduled to end. By way of another example, the duration can be the time during which two or more meeting attendees are talking, presenting, etc. (which may be before or after the time when the meeting is scheduled to begin, and/or before or after the time when the meeting is scheduled to end). The meeting lifecycle, however, begins when the meeting is requested or scheduled, and can end at various times as discussed above. Thus, the meeting lifecycle typically begins prior to the time when the meeting is scheduled to begin and typically extends beyond the time when the meeting is scheduled to end.

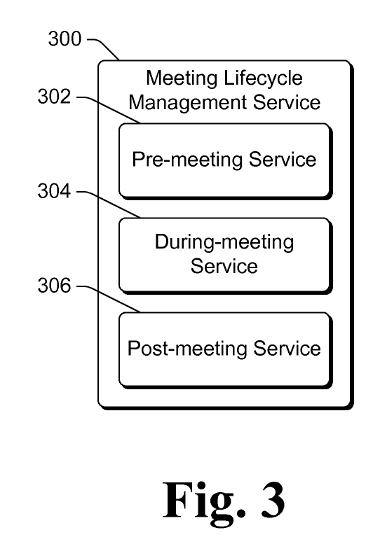

FIG. 3 illustrates an example meeting lifecycle management service 300 in accordance with one or more embodiments. Meeting lifecycle management service 300 can be, for example, a meeting lifecycle management service 102 of FIG. 1 or FIG. 2. Meeting lifecycle management service 300 includes a pre-meeting service 302, a during-meeting service 304, and a post-meeting service 306. Pre-meeting service 302 manages information related to the meeting prior to the meeting, during-meeting service 304 manages information related to the meeting during the meeting, and post-meeting service 306 manages information related to the meeting after the meeting. Although illustrated as separate services, one or more of services 302, 304, and 306 can alternatively be combined into a single service.

Each of services 302, 304, and 306 can be implemented as one or more computing devices, such as one or more servers, or alternatively one or more of services 302, 304, and 306 can be implemented on the same computing device. These services 302, 304, and 306 provide information or data to meeting management modules of computing devices (e.g., meeting management modules 112 of FIG. 1) for display or presentation to a user, and/or receive information or data from meeting management modules of computing devices. Additionally, the functionality (or parts of the functionality) discussed herein of one or more of services 302, 304, and 306 can be distributed to other computing devices, such as being performed by meeting management modules 112 of computing devices 104 of FIG. 1, being performed by other services, and so forth.

Each of services 302, 304, and 306 communicates with meeting management modules on various computing devices, allowing data and information to be provided to services 302, 304, and 306 from the computing devices as well as from the users of those computing devices. Similarly, this communication allows data and information to be provided from services 302, 304, and 306 to the computing devices as well as to the users of those computing devices. Inputs from a user to a service 302, 304, and/or 306 is typically performed by the meeting management module on the computing device being used by that user receiving a user input and providing an indication of that user input to the service 302, 304, and/or 306. Similarly, data and/or information to be provided to a user of a computing device is typically provided by the service 302, 304, and/or 306 to the meeting management module of the computing device being used by that user for display or other presentation to the user.

In one or more embodiments, access to information related to a meeting can be restricted to particular users (e.g., meeting attendees, meeting invitees, the user that scheduled the meeting, the supervisor of a meeting attendee or project, etc.). Access to information can be restricted to particular users in a variety of different manners. For example, meeting lifecycle management service 300 and/or a meeting management module can provide information to only computing devices being used by users with particular user identifiers (e.g., user identifiers corresponding to meeting invitees). By way of another example, meeting lifecycle management service 300 can have (or invoke) a verification process that provides information to only computing devices that provide (e.g., from a user of the computing device) a proper user identifier and password combination, a proper key, and so forth. By way of another example, meeting lifecycle management service can have (or invoke) a security process that encrypts information using a public key of a public/private key pair of a user or group of users that are allowed to access the information. The corresponding private key of the public/private key pair, kept secret by the user or group of users that are allowed to access the information, can be used to decrypt the information by the user or group of users that are allowed to access the information.

Pre-meeting service 302 manages information related to the meeting prior to the meeting. This management of information prior to the meeting can include various different functionality. Although examples of this functionality are included herein, it should be noted that management of information prior to the meeting can also include other functionality.

In one or more embodiments, pre-meeting service 302 provides a mechanism to share meeting content with other meeting invitees. A user of a computing device can select meeting content to be shared prior to the meeting as discussed above. This meeting content can be the actual data to be shared (e.g., a particular file or document), or can be a reference or link to the actual data to be shared (e.g., a link to a particular file or document stored on another service or device). Pre-meeting service 302 associates this meeting content with the meeting ID of the meeting, so that the meeting content is maintained as information related to the meeting. Other users on the same or different computing devices can then access (e.g., view, play back, print, etc.) this shared content before, during, and/or after the meeting.

In one or more embodiments, pre-meeting service 302 notifies meeting invitees of new meeting content. In response to receiving newly shared meeting content, pre-meeting service 302 sends a notification to each meeting invitee of the newly shared meeting content. The manner in which the notification is sent can vary, based on the contact information maintained by meeting lifecycle management service 300. Additional information regarding the newly shared meeting content can also be included with the notification, such as the title of the newly shared meeting content, the user that shared the newly shared meeting content, and so forth.

In one or more embodiments, pre-meeting service 302 enables multiple meeting invitees to simultaneously review and edit meeting content. As discussed above, information related to the meeting can be made available to meeting invitees prior to the meeting. Different users on different computing devices can simultaneously view information related to the meeting. Each user can also optionally modify or make changes to information related to the meeting, and such changes are provided to pre-meeting service 302. Pre-meeting service 302 maintains a record of these changes and provides these changes to other users that are currently viewing information related to the meeting as well as to users subsequently viewing information related to the meeting. Similarly, rather than editing meeting content, a user can make other changes to meeting content, such as removing or deleting meeting content from the meeting.

In one or more embodiments, pre-meeting service 302 records which meeting invitees change meeting content. Changing meeting content includes adding, removing, and/or otherwise modifying meeting content. An identifier of the meeting invitee that changes meeting content can be identified in different manners, such as being received from a meeting management module on a computing device being used by the meeting invitee to perform the change. Additional information regarding the changed meeting content can also be recorded by pre-meeting service 302, such as a date and/or time that the meeting content is changed, a type of computing device being used by the meeting invitee when performing the change, a number of times the meeting content has been changed, previous versions of the meeting content, and so forth. Pre-meeting service 302 can also optionally send a notification to each meeting invitee of the changed meeting content. The manner in which the notification is sent can vary, based on the contact information maintained by meeting lifecycle management service 300. Additional information regarding the changed meeting content can also be included with the notification, such as an identification of which meeting content was changed, an identification of the type of change, an identification of the user that changed the meeting content, and so forth.

In one or more embodiments, pre-meeting service 302 allows meeting invitees to see which other meeting invitees are planning to attend the meeting. Information related to the meeting, as discussed above, includes information regarding the people involved in the meeting. Pre-meeting service 302 can identify to meeting invitees which other meeting invitees have indicated they are planning to attend the meeting. A meeting invitee can indicate they are planning to attend the meeting in a variety of different manners, including single-touch actions (e.g., a single click, a single touch, a single swipe or other gesture), such as by selecting an “accept” button or option, inputting a particular gesture on a touchpad or touchscreen, and so forth. Pre-meeting service 302 can be notified each time a meeting invitee indicates they are planning to attend the meeting or alternatively can retrieve an indication of which meeting invitees are planning to attend a meeting from another service or module (e.g., meeting scheduling service 108 of FIG. 1). Similarly, pre-meeting service 302 can identify to meeting invitees which other meeting invitees have indicated they are not planning to attend the meeting, have indicated they may or may not attend the meeting, and so forth.

In one or more embodiments, pre-meeting service 302 determines which users are allowed to review meeting content. Meeting content is typically available to all meeting invitees. Pre-meeting service 302 can retrieve meeting content and provide that meeting content to computing devices used by the meeting invitees. Thus, even if the meeting content is typically accessed via a network or other device that a particular meeting invitee does not typically have access to, that particular meeting invitee can still review the meeting content. Alternatively, pre-meeting service 302 can restrict access to particular meeting content. For example, a user that schedules a meeting or alternatively another meeting invitee can select particular meeting content and specify the meeting content can be reviewed by only particular meeting invitees, can specify the meeting content can be review at only particular times (e.g., during the meeting), and so forth. Such restrictions can be received by, and maintained by, pre-meeting service 302.

In one or more embodiments, pre-meeting service 302 guides meeting invitees to meeting locations. Information related to the meeting, as discussed above, includes information regarding the location of the meeting. This information regarding the location of the meeting can be, for example, a particular room in a particular building, a particular street address, and so forth. Pre-meeting service 302 can guide meeting invitees to a particular meeting location by, for example, providing a map identifying the meeting location to the computing device being used by the meeting invitee. Furthermore, in situations in which the computing device being used by the meeting invitee is a location-aware device (e.g., a device supporting global positioning system (GPS) functionality), that device can provide its current location to pre-meeting service 302. Pre-meeting service 302 can, in turn, use this location information to guide the meeting invitee to the meeting location. For example, pre-meeting service 302 can provide a map to the device being used by the meeting invitee that identifies the meeting location as well as the current location of the meeting invitee, can provide a map or list of instructions to the device being used by the meeting invitee that specifies a route from the current location of the device to the meeting location, and so forth.

In one or more embodiments, pre-meeting service 302 notifies meeting invitees of changes to the meeting. Changes to information related to the meeting can be identified by pre-meeting service 302, such as changes in the meeting times, changes in the meeting location, changes in meeting invitees, cancellation of the meeting, and so forth. Pre-meeting service 302 can receive requests from meeting invitees to change information related to the meeting, or alternatively can automatically detect changes to information related to the meeting. For example, pre-meeting service 302 can monitor a meeting scheduling service (such as meeting scheduling service 108 of FIG. 1) and identify when information related to the meeting has changed. Pre-meeting service 302 can also optionally send a notification to each meeting invitee of the change to the meeting. The manner in which the notification is sent can vary, based on the contact information maintained by meeting lifecycle management service 300. Additional information regarding the change to the meeting can also be included with the notification, such as an identification of which information related to the meeting was changed, an identification of the user that changed the meeting content, and so forth.

During-meeting service 304 manages information related to the meeting during the meeting. This management of information during the meeting can include various different functionality. Although examples of this functionality are included herein, it should be noted that management of information during the meeting can also include other functionality.

In one or more embodiments, during-meeting service 304 maintains a record of the information related to the meeting during the meeting (e.g., a record of anything that happens during the meeting). This record maintained by during-meeting service 304 can include an audio and/or video recording of the meeting, indications of which meeting content was accessed (e.g., which documents were opened and viewed) at what times during the meeting, indications of which portions of meeting content (e.g., which pages of a document, which slides of a slide deck) were displayed at what times during the meeting, which meeting invitees joined the meeting at which times, which meeting attendees left the meeting at which times, and so forth. This record is maintained, and post-meeting service 306 allows users to retrieve this record and access the meeting content and other information related to the meeting as discussed in more detail below.

In one or more embodiments, during-meeting service 304 allows status updates that are visible to meeting invitees. During the meeting, different meeting invitees can provide various updates regarding their status, such as an indication that they are running late to the meeting, an indication that they are joining the meeting, an indication that they need to leave the meeting, and so forth. These updates can be provided by a meeting invitee via the meeting management module on the computing device that the meeting invitee is using. The meeting management module provides these status updates to during-meeting service 304, which in turn provides the status updates to the computing devices of the other meeting invitees (or meeting attendees).

In one or more embodiments, during-meeting service 304 allows a meeting to be started from any device. A meeting can be started in a variety of different manners, as discussed above, such as by selecting a button or icon, selecting a link or other reference to a phone number or other identifier of a conference call, and so forth. The meeting can be started by any of the meeting invitees from any of the devices being used by the meeting invitees. Similarly, meeting invitees can join the meeting by selecting a particular button or icon, selecting a link or other reference to a phone number or other identifier of a conference call, and so forth.

In one or more embodiments, during-meeting service 304 notifies meeting invitees that the meeting has started. When the meeting starts, during-meeting service 304 sends a notification to each meeting invitee that the meeting has started. Alternatively, during-meeting service 304 may not send a notification to one or more meeting invitees, such as the meeting invitee that started the meeting. The manner in which the notification is sent can vary, based on the contact information maintained by meeting lifecycle management service 300.

In one or more embodiments, during-meeting service 304 automatically creates and starts audio and/or video conferencing for the meeting. For a meeting that includes a phone number or other identifier of the conference call, during-meeting service 304 can automatically establish the conference call using that phone number or identifier. The manner in which the conference call is established can vary based on the manner in which the audio and/or video conferencing service being used operates. Additionally, meeting invitees can join the audio and/or video conference by selection of a single button, selection of a single link, inputting of a single gesture to the computing device, and so forth. In response to such a user selection or input, the meeting management module on the user's computing device provides the appropriate information to the audio and/or video conferencing service for the user's computing device to join the conference. This appropriate information can be included by the user scheduling the meeting and included as information related to the meeting, and/or can be received from during-meeting service 304 (e.g., information received by service 304 in establishing a conference call).

In one or more embodiments, during-meeting service 304 uses social cues to encourage meeting attendance. During-meeting service 304 provides notifications to meeting invitees that have not yet joined the meeting. The manner in which the notification is sent can vary, based on the contact information maintained by meeting lifecycle management service 300. Such notifications can serve as a reminder of the meeting, and can also include other information related to the meeting. For example, such notifications can include an indication of how many meeting invitees have already joined the meeting, an indication of particular meeting invitees that have already joined the meeting (e.g., notifying a meeting invitee that his or her boss has already joined the meeting), and so forth.

In one or more embodiments, during-meeting service 304 coordinates access to meeting content. This management of access is analogous to pre-meeting service 302 determining which users are allowed to review meeting content discussed above. However, the management performed by during-meeting service 304 is performed during the meeting as opposed to pre-meeting service 302 determining which users are allowed to review meeting content prior to the meeting.

In one or more embodiments, during-meeting service 304 records events that happen during a meeting and associated context for those events. Different events can be identified in different manners, such as being preconfigured into during-meeting service 304, being specified by a user that scheduled the meeting or another meeting invitee, and so forth. An event refers to an occurrence of some significance relative to the meeting. For example, an event can be a particular action that is performed by a meeting attendee, displaying of particular meeting content during the meeting, a change in meeting content (e.g., displaying of a new page or slide), and so forth. An action that is performed by a meeting attendee can be a user request, such as a request to bookmark or capture a particular point of the meeting or a request to create a new action item for a meeting attendee. Such a user request can be input in a variety of different manners, including single-touch actions (e.g., a single click, a single touch, a single swipe or other gesture), such as by selecting a “bookmark” or “action item” button or icon, inputting a particular gesture on a touchpad or touchscreen, and so forth.

When an event occurs, during-meeting service 304 records an indication describing the event that occurred (e.g., an indication of the particular action that is performed by the meeting attendee) as well as associated context for the event. This associated context for the event can also be referred to as the state or state elements of the meeting. This associated context refers to any of a variety of information related to the meeting, such as meeting content being displayed at the time of the event, meeting content displayed an amount of time prior to and/or after the event, audio and/or video for the meeting for an amount of time prior to and/or after the event, an identification of meeting attendees that have joined the meeting at the time of the event, a date and/or time of the event, a current agenda item for the meeting, a location of the meeting, and so forth.

For example, an event can be a user request to create a new action item for a meeting attendee describing a particular follow-up action that the meeting attendee is to perform after the meeting. Such a new action item can be created by that meeting attendee, or alternatively by another meeting attendee, in a variety of different manners including single-touch actions (e.g., a single click, a single touch, a single swipe or other gesture), such as selection of an icon or button, selection of a menu item, inputting a particular gesture on a touchscreen or touchpad, and so forth. In response to such an event, during-meeting service 304 generates a record including both a description of the new action item (e.g., a text entry provided by the user that requested creation of the new action item) as well as the associated context for that new action item. This associated context can be, for example, an indication of a particular page or slide of meeting content being displayed when the user request to create the new action item is received, audio and/or video of the meeting recorded for 60 seconds before and 60 seconds after the user request to create the new action item is received, and so forth. During-meeting service 304 maintains this record of the action item and the associated context, allowing the meeting attendee to subsequently retrieve and review (e.g., display, play back, etc.) the action item and the associated context. Thus, rather than having just a single line action item to work from, the meeting attendee can refer back to the context of the meeting in which that action item was created, providing the meeting attendee with additional information regarding the follow-up action that he or she is to take. During-meeting service 304 can optionally include in the record of the new action item an indication of the meeting attendee to which the action item is assigned. After the meeting, post-meeting service 306 can allow all meeting attendees (or meeting invitees or other users) to retrieve this record, or alternatively can restrict access to this record to particular meeting attendees (or meeting invitees or other users) such as allowing only the meeting attendee identified in the record to retrieve the record.

By way of another example, an event can be a user request to bookmark or capture a particular point of the meeting. Such a user request can be input in a variety of different manners including single-touch actions (e.g., a single click, a single touch, a single swipe or other gesture), such as selection of an icon or button, selection of a menu item, inputting a particular gesture on a touchscreen or touchpad, and so forth. In response to such an event, during-meeting service 304 generates a record of the context of the meeting at the point in time that the user request to bookmark or capture a particular point of the meeting is received. This record is analogous to the record discussed above with reference to creation of a new action item, except that no action item exists. However, an identifier of the event can be maintained in the record, such as an indication of a particular bookmark, an indication of a particular point in time at which the event occurred, and so forth. During-meeting service 304 maintains this record of the event and the associated context, allowing the meeting attendee to subsequently retrieve and review (e.g., display, play back, etc.) the context associated with the event. Thus, if a meeting attendee sees a slide or document page of particular importance to him or her, hears a comment of particular importance to him or her, and so forth, he or she can request a bookmark at that time during the meeting. The meeting attendee can then refer back to this record after the meeting and be presented with the context of the meeting at that time. During-meeting service 304 can optionally include in the record of the event an indication of the meeting attendee that requested the bookmark or capturing. After the meeting, post-meeting service 306 can allow all meeting attendees (or meeting invitees or other users) to retrieve this record, or alternatively can restrict access to this record to particular meeting attendees (or meeting invitees or other users) such as allowing only the meeting attendee identified in the record to retrieve the record.

By way of yet another example, an event can be a change in the page or slide of meeting content being displayed. In response to such an event, during-meeting service 304 generates a record of the context of the meeting at the point in time that the change in the page or slide of meeting content being displayed is made. This record is analogous to the record discussed above with reference to a user request to bookmark or capture a particular point of the meeting, except that no user request to bookmark or capture a particular point of the meeting is received (although a user request to change the page or slide of meeting content can optionally be received). However, an identifier of the event can be maintained in the record, such as an indication of a particular page or slide, an indication of a particular point in time at which the event occurred, and so forth. During-meeting service 304 maintains this record of the change in the page or slide of meeting content and the associated context, allowing the meeting attendees to subsequently retrieve and review (e.g., display, play back, etc.) the context associated with the change in the page or slide of meeting content. Thus, if a meeting attendee (or meeting invitee or other user) desires to refer back to particular point of the meeting at which a change in the page or slide of meeting content was made, the meeting attendee (or meeting invitee or other user) can refer back to this record and be presented with the context of the meeting at that time.

In one or more embodiments, during-meeting service 304 facilitates voting and multi-party brainstorming. In situations in which a vote or poll is desired during a meeting, the meeting management modules of the computing devices being used by the meeting attendees receive indications from the meeting attendees of their votes. These indications are returned to during-meeting service 304 which in turn tabulates, counts, combines, or otherwise generates the result of the vote. During-meeting service 304 can return this result of the vote to the meeting management modules for presentation to the meeting attendees.

Similarly, in situations in which brainstorming is desired to be performed during the meeting, the meeting management modules of the computing devices being used by the meeting attendees receive brainstorming ideas (e.g., user inputs of text or other characters) from the meeting attendees. These brainstorming ideas are provided to during-meeting service 304 which in turn provides the brainstorming ideas to the other meeting management modules. Thus, rather than having a single meeting attendee responsible for generating a list of brainstorming ideas, each meeting attendee is able to provide brainstorming ideas and view the brainstorming ideas input by other meeting attendees. Alternatively, the meeting management modules can communicate brainstorming inputs received from their respective meeting attendees to one another independent of during-meeting service 304.

In one or more embodiments, during-meeting service 304 tailors user experiences to the particular types of computing devices being used by the various meeting attendees. During-meeting service 304 can obtain an indication of a particular type or class of computing device being used by each meeting attendee in a variety of different manners, such as being received from the meeting management modules of the computing devices being used by the meeting attendees, being provided by the user scheduled a meeting, and so forth. The type or class of computing device can indicate, for example, a size of a screen or other display of the computing device (e.g., whether the display is a 100 inch television screen or a 4 inch mobile device screen), a color depth of a screen or other display of the computing device (e.g., whether the display supports 16 bit color or only grayscale), whether the computing device has a separate keypad or is only a touchscreen, and so forth.

During-meeting service 304 tailors meeting content to the particular type or class of computing device. For example, during-meeting service 304 can provide a higher resolution version of a slide or page of a document to a computing device having a 100 inch screen than to a device having a 4 inch screen. By way of another example, during-meeting service 304 can provide a color version of a slide or page of the document to a computing device supporting 16-bit color and a grayscale version of the slide or page of the document to a computing device supporting only grayscale. These different versions of the document can be pre-generated and stored, and then accessed by during-meeting service 304 during the meeting. Alternatively, these different versions of the document can be generated by during-meeting service 304 during the meeting.

In alternate embodiments, rather than during-meeting service 304 tailoring meeting content to the particular type or class of computing device, the computing device itself can tailor the meeting content to the particular type or class of computing device. For example, a meeting management module 112 of FIG. 1 can tailor the meeting content to the particular type or class of computing device that includes that meeting management module 112. In such embodiments, meeting management module 112 can receive one or more versions of content (e.g., a highest resolution and greatest color depth version available), and then modify one of the one or more received versions of content as appropriate to tailor the meeting content to the particular type or class of computing device that includes the meeting management module 112.

In one or more embodiments, during-meeting service 304 facilitates projecting one computing device to one or more other computing devices. Projecting one computing device to one or more other computing devices refers to presenting one or more images (e.g., a video) of the display of the one computing device on the displays of the one or more other computing devices. The one or more images can be images of the entire display of the computing device, or alternatively one or more images of a portion of the display of the computing device (e.g., one or more windows of the display). A user request can be received at one computing device to project the display of that computing device to one or more other computing devices. The request can be received in a variety of different manners, including single-touch actions (e.g., a single click, a single touch, a single swipe or other gesture), such as user selection of an icon or button, user selection of a menu item, user input of a particular gesture on a touchscreen or touchpad, and so forth. Similarly, a user request can be received at the computing device to cease projection of the display of that computing device in a variety of different manners. The user can also input a request in a variety of different manners that identifies a particular one or more meeting attendees (e.g., user selection of the meeting attendees from a list of current meeting attendees) to which the display of the computing device is to be projected and in response the display is projected to only the computing devices of the selected one or more meeting attendees. Alternatively, the display of the computing device can be projected to the computing devices of all meeting attendees.

The meeting management module of the device projecting its display captures one or more images or screen shots (e.g., a video) of the display of that computing device. The meeting management module provides the captured one or more images to during-meeting service 304 which in turn provides the captured one or more images to the other meeting management modules. These other meeting management modules also display these captured one or more images, allowing the other meeting attendees to view the display of the device projecting its display. Alternatively, meeting management modules can communicate the captured one or more images to the meeting management modules of the other computing devices being used by the meeting attendees independent of during-meeting service 304. Additionally, it should be noted that the one or more images of the projection of the screen are meeting content and can be recorded as meeting content of the meeting.

In one or more embodiments, during-meeting service 304 facilitates sharing of meeting content with meeting attendees. This sharing of meeting content is analogous to pre-meeting service 302 sharing of meeting content with other meeting invitees discussed above. However, the sharing facilitated by during-meeting service 304 is performed during the meeting as opposed to pre-meeting service 302 sharing meeting content prior to the meeting. A user input requesting to share particular content with meeting attendees can be input in a variety of manners, including single-touch actions (e.g., a single click, a single touch, a single swipe or other gesture), such as a user dragging and dropping the particular content on a “share” button or icon, a user selecting particular content and then selecting a particular button or icon or entering a particular gesture on a touchscreen or touchpad, and so forth.

In one or more embodiments, during-meeting service 304 facilitates multi-party collaboration on the same meeting content. The meeting content is available to meeting attendees during the meeting. This multi-party collaboration is analogous to pre-meeting service 302 enabling multiple meeting invitees to simultaneously review and edit meeting content discussed above. However, the multi-party collaboration facilitated by during-meeting service 304 is performed during the meeting as opposed to pre-meeting service 302 enabling multiple meeting invitees to simultaneously review and edit meeting content prior to the meeting.

Post-meeting service 306 manages information related to the meeting after the meeting. This management of information after the meeting can include various different functionality. Although examples of this functionality are included herein, it should be noted that management of information after the meeting can also include other functionality.

In one or more embodiments, post-meeting service 306 creates and distributes a meeting summary for the meeting. Post-meeting service 306 can create a meeting summary automatically or alternatively in response to a user input by the user that scheduled a meeting or in response to a user input from another meeting invitee. A user can request creation of a meeting summary in a variety of different manners, including single-touch actions (e.g., a single click, a single touch, a single swipe or other gesture), such as by selecting a “summary” button or icon, inputting a particular gesture on a touchpad or touchscreen, and so forth.

The meeting summary can include a variety of different information related to the meeting. Any of the meeting content or other information related to the meeting that is recorded by during-meeting service 304 as discussed above can be included in the meeting summary. For example, the meeting summary can include a list of meeting attendees, a list of meeting content (e.g., documents presented during a meeting, an audio and/or video recording of the meeting), references or other links to meeting content (e.g., links to documents that can be selected by a user to access the documents), a list of action items created during the meeting (and references or links to the records generated by during-meeting service 304 for those action items so that a user can retrieve the action item and associated context), and so forth.

Post-meeting service 306 can also distribute the meeting summary. The meeting summary can be distributed to meeting attendees, meeting invitees, and/or other users (e.g., as specified by the user that schedule the meeting). The manner in which the meeting summary is distributed can vary, based on the contact information maintained by meeting lifecycle management service 300. Alternatively, the meeting summary can be maintained by post-meeting service 306 and provide it to a user in response to a request from the user for the meeting summary.

In one or more embodiments, post-meeting service 306 allows access to the meeting content after the meeting. As discussed above, the meeting content and other information related to the meeting is recorded by during-meeting service 304. Post-meeting service 306 maintains this meeting content and other information, allowing users to access the meeting content and other information after the meeting (e.g., via the meeting management module of a computing device). During-meeting service 304 can optionally restrict access to this meeting content and other information to particular users, such as only meeting attendees, only meeting invitees, only the user that scheduled a meeting, and so forth.

Post-meeting service 306 can delete or otherwise dispose of this meeting content and other information at some point after the meeting. The point at which the meeting content and other information is deleted can be determined in different manners, such as based on available storage space, based on an amount of time (e.g., one year after the meeting occurred, three months after the most recent user access to the meeting content or other information, etc.), based on a user request to delete the meeting content and other information, and so forth.

In one or more embodiments, post-meeting service 306 associates private user notes with the meeting. A meeting invitee can optionally input private notes regarding the meeting. These private notes can take a variety of different forms, such as text inputs, audio inputs, and so forth. For example, the meeting management module of the computing device being used by the meeting invitee can provide audio recording functionality, word processing functionality, and so forth can be used by the meeting invitee to input private notes. Such private notes can be input before, during, and/or after the meeting. When input during a meeting, input of a private note can be viewed as an event as discussed above, and a record of context associated with the inputting of the private note (e.g., an indication of a particular page or slide of meeting content being displayed, audio and/or video of the meeting recorded for 60 seconds before and 60 seconds after the event, and so forth) can also be generated.

The meeting management module for the computing device used by the meeting invitee inputting the private note provides the private note to post-meeting service 306. Post-meeting service 306 maintains the private note as associated with the meeting, allowing the meeting invitee that input the private note to subsequently retrieve and view (or otherwise playback) the private note, optionally along with the context associated with the inputting a private note. Post-meeting service 306 restricts access to the private note, allowing the private note to be retrieved only by the meeting invitee that input the private note.

In one or more embodiments, post-meeting service 306 notifies other users that the meeting location is available. The information related to the meeting, as discussed above, includes information regarding the location of the meeting. Post-meeting service 306 can also obtain scheduling information for that location for the time after the meeting, including contact information (e.g., email address, telephone number, etc.) for meeting invitees to the next meeting on the schedule at that location (or the user that scheduled the next meeting on the schedule at that location). The scheduling information can be obtained from different sources, such as from meeting scheduling service 108 of FIG. 1, from another service or module, and so forth.

In situations in which the meeting ends early (e.g., before the scheduled ending time for the meeting) post-meeting service 306 can send a notification to a meeting invitee of the next meeting on the schedule at that location. The manner in which the notification is sent can vary, based on the contact information for meeting invitees to the next meeting on the schedule at that location. This notification allows meeting invitees of the next meeting on the schedule at that location to know that the meeting location is free and available for them to start their meeting.

In one or more embodiments, post-meeting service 306 facilitates rescheduling follow-up meetings. Post-meeting service 306 maintains various information related to the meeting as discussed above. This information can be leveraged if a subsequent follow-up meeting is desired. A user can request that a follow-up meeting be scheduled in a variety of different manners, including single-touch actions (e.g., a single click, a single touch, a single swipe or other gesture), such as by selecting a “follow-up meeting” button or icon, inputting a particular gesture on a touchpad or touchscreen, and so forth. A new meeting request for a follow-up meeting can be generated that includes information related to the meeting, such as meeting invitees, meeting content, and so forth. Thus, the user request for the follow-up meeting can be pre-populated with the appropriate meeting invitees, references and links to meeting content discussed in the previous meeting, and so forth. The new meeting request for the follow-up meeting can be generated (e.g., by pre-meeting service 302, by a meeting management module of the computing device, etc.) and provided to a meeting scheduling service (e.g., meeting scheduling service 108 of FIG. 1) or alternatively can be generated by a meeting scheduling service (e.g., meeting scheduling service 108 of FIG. 1).

In one or more embodiments, post-meeting service 306 aggregates related meetings. Post-meeting service 306 maintains a record of meetings as well as any follow-up meetings to those meetings. Similarly, a recurring meeting can be scheduled (e.g., weekly, monthly, quarterly, etc.) and post-meeting service 306 can maintain a record of the multiple meeting occurrences of that recurring meeting. A user, via the meeting management module of a computing device, can access these meeting records. The user can thus readily identify the different related meetings (e.g., a meeting and its follow-up meetings, multiple meeting occurrences of a recurring meeting), and readily access information related to each of these meetings. For example, the user can review which meeting content was discussed at which of the related meetings, what action items if any were generated during particular ones of the related meetings, and so forth.

In one or more embodiments, post-meeting service 306 facilitates recall of previous meetings and information related to the meeting. Post-meeting service 306 can identify potential meetings of interest to a user based on meetings that that user has been invited to (or has attended). These meetings may not be related in terms of one being a follow-up meeting or being a recurring meeting, however may be related based on meeting invitees and/or meeting attendees. Post-meeting service 306 can provide for a user a list of meetings that he or she has been invited to (or has attended). This list can be filtered based on various criteria provided by the user, such as other meeting invitees and/or meeting attendees, date and/or time of the meeting, location of the meeting, subject or description of the meeting, and so forth. Thus, post-meeting service 306 allows the user to easily identify and/or search for other meetings that he or she has been invited to (or has attended).

In one or more embodiments, meeting lifecycle management service 300 can also communicate with other services or applications to provide various functionality related to the meeting lifecycle. A document that is included as meeting content in one or more meetings can be stored with an indication that it was included as meeting content in one or more meetings. This indication can take a variety of different forms, such as metadata associated with the document, a particular character or identifier in the name of the document, and so forth. The indication can include meeting identifiers of the meetings for which the document was meeting content, or alternatively simply an indication that the document was meeting content. When the document is accessed via the other service or application, the user can be notified that the document was meeting content for one or more meetings, and an indication of those meetings can be provided to the user. E.g., meeting summaries of those meetings can be provided to the user, the meeting content and other information maintained by post-meeting service 306 can be retrieved for the user, and so forth.

For example, a word processing document may be included as meeting content in multiple different meetings. An indication that the word processing document was included as meeting content in one or more meetings can be stored in metadata associated with the word processing document. When a user accesses that word processing document using a word processing program, an indication can be presented to the user notifying the user that the document had been used as meeting content in one or more meetings. The user can then request information regarding those meetings, in response to which post-meeting service 306 identifies the one or more meetings that used the document as meeting content and provides all the meeting content and other information to the user.

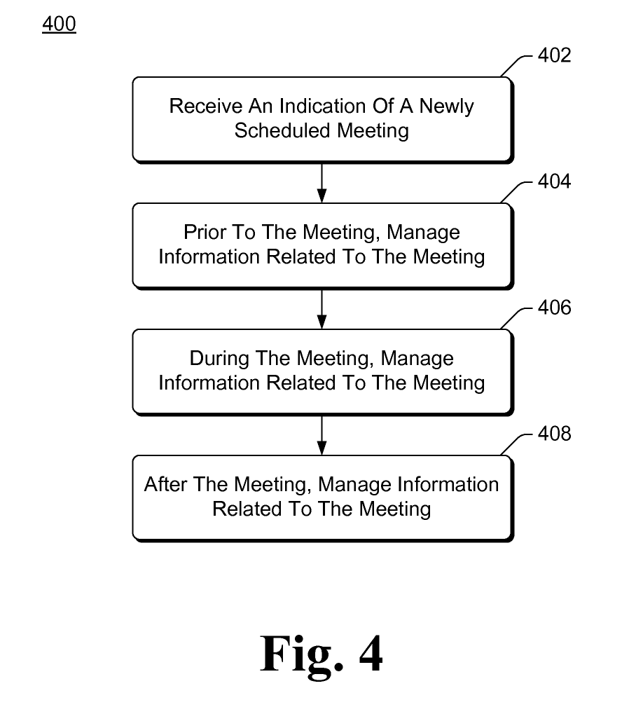

FIG. 4 is a flowchart illustrating an example process 400 for meeting lifecycle management in accordance with one or more embodiments. Process 400 can be implemented in software, firmware, hardware, or combinations thereof. Process 400 can be carried out by a meeting lifecycle management service (such as service 102 of FIG. 1 or FIG. 2, or service 300 of FIG. 3), or alternatively can be carried out by one or more other devices, services, and/or modules. Process 400 is shown as a set of acts and is not limited to the order shown for performing the operations of the various acts. Process 400 is an example process for meeting lifecycle management; additional discussions of meeting lifecycle management are included herein with reference to different figures.

In process 400, an indication of a newly scheduling meeting is received (act 402). This indication can be received in different manners, such as from a meeting scheduling service as discussed above.

Prior to the meeting, information related to the meeting is managed (act 404). A variety of different information related to the meeting can be managed prior to the meeting as discussed above. Additionally, managing this information prior to the meeting can include various functionality as discussed above.

During the meeting, information related to the meeting is managed (act 406). A variety of different information related to the meeting can be managed during the meeting as discussed above. Additionally, managing this information during the meeting can include various functionality as discussed above.

After the meeting, information related to the meeting is managed (act 408). A variety of different information related to the meeting can be managed after the meeting as discussed above. Additionally, managing this information after the meeting can include various functionality as discussed above.

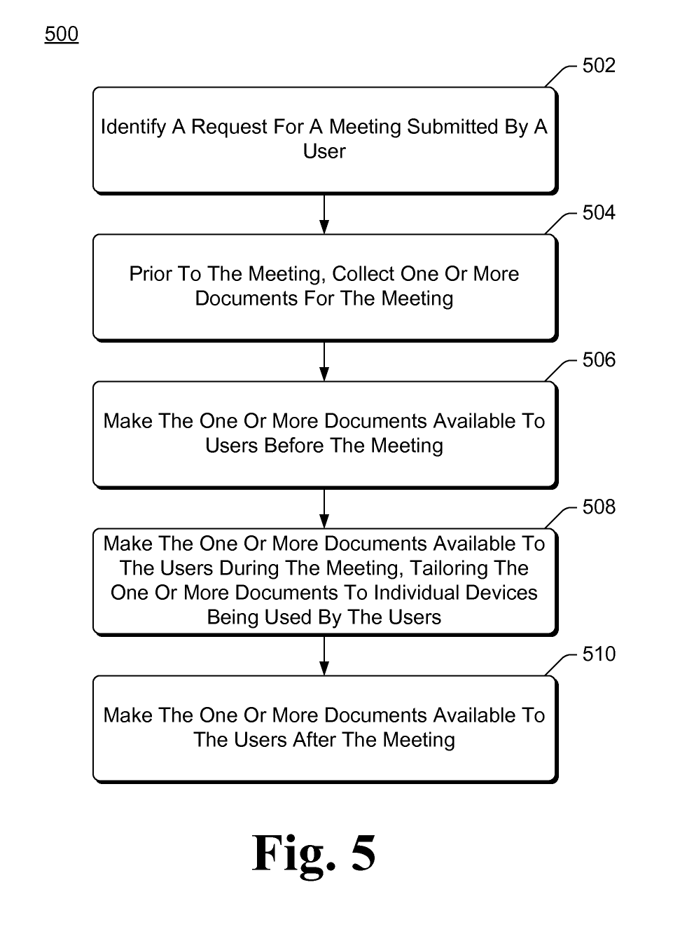

FIG. 5 is a flowchart illustrating another example process 500 for meeting lifecycle management in accordance with one or more embodiments. Process 500 can be implemented in software, firmware, hardware, or combinations thereof. Process 500 can be carried out by a meeting lifecycle management service (such as service 102 of FIG. 1 or FIG. 2, or service 300 of FIG. 3), or alternatively can be carried out by one or more other devices, services, and/or modules. Process 500 is shown as a set of acts and is not limited to the order shown for performing the operations of the various acts. Process 500 is an example process for meeting lifecycle management; additional discussions of meeting lifecycle management are included herein with reference to different figures.

In process 500, a request submitted by a user for a meeting is identified (act 502). The request can be identified in different manners, such as an indication of the request being received from a meeting scheduling service or a computing device being used by the user as discussed above.

Prior to the meeting, zero or more documents for the meeting are collected (act 504). Various documents can be collected, such as text documents, spreadsheet documents, presentation slides, video, audio, and so forth. The documents can be collected in different manners, such as providing meeting content to share with other meeting invitees to a pre-meeting service as discussed above.

The collected one or more documents are made available to users before the meeting (act 506). These users can be meeting invitees, as well as other users (e.g., the supervisor of a meeting invitee, a manager of a project or team that the meeting invitee is part of, etc.). The one or more documents can be tailored to the computing devices being used by the users, tailoring the user experiences for those users to the particular types of computing devices they are using as discussed above.

The collected one or more documents are made available to the meeting attendees during the meeting (act 508). The one or more documents can also be tailored to the computing devices being used by the meeting attendees as discussed above with respect to act 506.

The one or more documents are made available to the users after the meeting (act 510). The one or more documents can be included in a meeting summary or otherwise retrieved by the meeting attendees as discussed above. The one or more documents can also be tailored to the computing devices being used by the meeting attendees as discussed with respect to act 506. The user can be a meeting attendee, meeting invitee, or other users as discussed above.

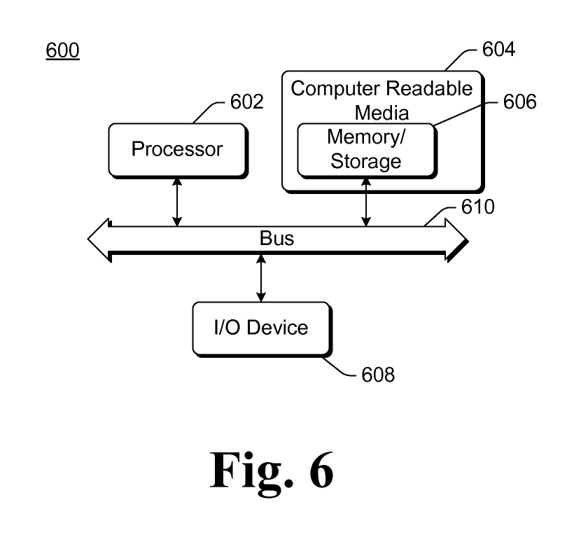

FIG. 6 illustrates an example computing device 600 that can be configured to implement at least parts of the meeting lifecycle management in accordance with one or more embodiments. Computing device 600 can be, for example, a computing device 104 of FIG. 1 or FIG. 2. Computing device 600 can also implement at least part of the various services discussed herein, such as meeting lifecycle management service 102 of FIG. 1 or FIG. 2, meeting scheduling service 108, or meeting support service 110 of FIG. 1, or meeting lifecycle management service 300 of FIG. 3.

Computing device 600 includes one or more processors or processing units 602, one or more computer readable media 604 which can include one or more memory and/or storage components 606, one or more input/output (I/O) devices 608, and a bus 610 that allows the various components and devices to communicate with one another. Computer readable media 604 and/or one or more I/O devices 608 can be included as part of, or alternatively may be coupled to, computing device 600. Bus 610 represents one or more of several types of bus structures, including a memory bus or memory controller, a peripheral bus, an accelerated graphics port, a processor or local bus, and so forth using a variety of different bus architectures. Bus 610 can include wired and/or wireless buses.

Memory/storage component 606 represents one or more computer storage media. Component 606 can include volatile media (such as random access memory (RAM)) and/or nonvolatile media (such as read only memory (ROM), Flash memory, optical disks, magnetic disks, and so forth). Component 606 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 602. It is to be appreciated that different instructions can be stored in different components of computing device 600, such as in a processing unit 602, in various cache memories of a processing unit 602, in other cache memories of device 600 (not shown), on other computer readable media, and so forth. Additionally, it is to be appreciated that the location where instructions are stored in computing device 600 can change over time.

One or more input/output devices 608 allow a user to enter commands and information to computing device 600, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 6. The features of the meeting lifecycle management techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving, at a centralized meeting lifecycle management service, an indication of a newly scheduled meeting;
managing, via the centralized meeting lifecycle management service prior to the meeting, information related to the meeting;
managing, via the centralized meeting lifecycle management service during the meeting, information related to the meeting; and
managing, via the centralized meeting lifecycle management service after the meeting ends, information related to the meeting.

2. A method as recited in claim 1, wherein receiving the indication of the newly scheduled meeting comprises receiving the indication from a meeting scheduling service used by a user to schedule the newly scheduled meeting.

3. A method as recited in claim 1, wherein managing, during the meeting, the information related to the meeting comprises identifying an event that happens during the meeting and generating a record including both a description of the event and an associated context for the event.

4. A method as recited in claim 3, wherein the associated context for the event includes audio and/or video of the meeting for an amount of time prior to the event and for an amount of time after the event.

5. A method as recited in claim 3, wherein managing, after the meeting ends, the information related to the meeting comprises allowing an attendee of the meeting to retrieve both the description of the event and the associated context for the event.

6. A method as recited in claim 3, wherein the event is a user request input as a single-touch action by the user.

7. A method as recited in claim 1, wherein managing, during the meeting, the information related to the meeting comprises sending a notification to one or more meeting invitees that the meeting has started.

8. A method as recited in claim 1, wherein managing, during the meeting, the information related to the meeting comprises tailoring, for each of multiple meeting attendees, meeting content for the meeting to a type of computing device being used by the meeting attendee.

9. A method as recited in claim 1, wherein managing, during the meeting, the information related to the meeting comprises receiving images of a display captured at one computing device used by one of multiple meeting attendees, and providing the images of the display to other computing devices used by other ones of the multiple meeting attendees.

10. A method as recited in claim 1, wherein managing, after the meeting ends, the information related to the meeting comprises creating and distributing a meeting summary for the meeting.

11. One or more computer storage media having stored thereon multiple instructions that implement a meeting lifecycle management service and that, when executed by one or more processors, cause the one or more processors to:
identify, by the meeting lifecycle management service, a request for a meeting submitted by a user;
collect, by the meeting lifecycle management service, one or more documents for the meeting prior to the meeting;
make the one or more documents available to users before the meeting;
make the one or more documents available to the users during the meeting, including tailoring, for each of multiple users, the one or more documents to a type of computing device being used by the user; and
make the one or more documents available to the users after the meeting.

12. One or more computer storage media as recited in claim 11, wherein the multiple instructions further cause the one or more processors to receive images of a display captured at one computing device used by one of multiple meeting attendees, and provide the images of the display to other computing devices used by other ones of the multiple meeting attendees.

13. One or more computer storage media as recited in claim 11, wherein the multiple instructions further cause the one or more processors to receive one or more additional documents during the meeting and make the one or more additional documents available to the users during the meeting, including tailoring, for each of the multiple users, the one or more additional documents to a type of computing device being used by the user.

14. One or more computer storage media as recited in claim 11, wherein the multiple instructions further cause the one or more processors to allow the meeting to be started from any of the computing devices being used by any of multiple meeting attendees.

15. One or more computer storage media as recited in claim 11, wherein the multiple instructions further cause the one or more processors to create and distribute, after the meeting, a summary of the meeting that includes, for each of the one or more documents, a reference to the document.

16. One or more computer storage media as recited in claim 11, wherein the multiple instructions further cause the one or more processors to identify, during the meeting, an event and generate a record including both a description of the event and an associated context for the event.

17. One or more computer storage media as recited in claim 16, wherein the associated context for the event includes an indication of one of the one or more documents being displayed at the time of the event.

18. One or more computer storage media as recited in claim 16, wherein the associated context for the event includes audio and/or video of the meeting for an amount of time prior to the event and for an amount of time after the event.

19. One or more computer storage media as recited in claim 16, wherein the event is a user request input as a single-touch action by the user.

20. One or more computer storage media having stored thereon multiple instructions that, when executed by one or more processors of a computing device, cause the one or more processors to:
receive, at a centralized meeting lifecycle management service, an indication of a newly scheduled meeting;
manage, via the centralized meeting lifecycle management service prior to the meeting, information related to the meeting;
manage, via the centralized meeting lifecycle management service during the meeting, information related to the meeting, including to receive a user request to create an action item for a meeting attendee during the meeting and generate a record that includes both a description of the action item and an associated context for the action item, the associated context including audio and/or video of the meeting for an amount of time prior to the user request being received and for an amount of time after the user request being received; and
manage, via the centralized meeting lifecycle management service after the meeting ends, information related to the meeting, including to create and distribute a meeting summary for the meeting, the meeting summary including the action item and a link to the record.
